(19) United States
(12) Patent Application Publication
(10) Pub. No.: US 2008/0300108 A1
(43) Pub. Date: Dec. 4, 2008

(54) TORQUE TRANSFER DEVICE AND SYSTEM

(76) Inventors: William N. Eybergen, Windsor (CA); Paul Norman Herrmann, Clinton Township, MI (US); Matthew P. Scarbrough, Canton, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/756,199

(22) Filed: May 31, 2007

(51) Int. Cl. B60W 10/02

(52) U.S. Cl. 477/176

(57) ABSTRACT

A device for a motor vehicle is provided. The device may comprise an input shaft for supplying torque, a clutch configured for selectively transferring the torque, a first gear configured for connection to the clutch, and a second gear connected to the first gear. The second gear may be fixed to the device so that the second gear is not free to rotate. The device may further comprise an output shaft for receiving the torque. The device may be configured to control the amount of torque transferred to the output shaft.

### BACKGROUND

a. Field of Invention

The invention relates generally to a device for a motor vehicle, including a device for a motor vehicle for the transfer of full driveline torque by clutching a fraction of driveline torque.

b. Description of Related Art

A motor vehicle may be driven on a number of different road surfaces. Different road surfaces may have different coefficients of friction. A driver may lose control when transferring to a different road surface. For example, a driver may oversteer or overcompensate on changing road surfaces. A difference in rotation between the front and rear wheels may indicate a slip condition or a loss of traction. Tire compliance standards provide for absorption of about a 5% difference in rotation between the front and rear wheels. However, in some circumstances, the rear wheels may be rotating up to about 6% faster than the front wheel, which will not be addressed by tire compliance standards. The amount of torque transferred to the rear wheel may be varied in order to improve driver control and address a slip condition or loss of traction. Attempting to control the torque transferred to the rear axle of a motor vehicle by sensing varying road surfaces is complex.

A device to manage the amount of torque that is transferred to the rear axle of a motor vehicle may be desirable in order to improve control and drivability of the motor vehicle and redress a slip condition or loss of traction. The device may include a clutch pack for reducing or increasing torque to the rear wheels. The clutch pack may be designed to meet vehicle packaging constraints.

A device that may be controlled by sensing parameters other than changing road surfaces in order to control and manage the amount of torque that is transferred to the rear axle of a motor vehicle may also be desirable. For example, a device that may be controlled by sensing rear wheel speed and/or the difference between rear wheel speed and front wheel speed may be used to improve the control and drivability of a motor vehicle.

### SUMMARY

A device for a motor vehicle is provided. The device may comprise an input shaft for supplying torque, a clutch configured for selectively transferring the torque, a first gear configured for connection to the clutch, and a second gear connected to the first gear. The second gear may be fixed to the device so that the second gear is not free to rotate. The device may further comprise an output shaft for receiving the torque. The device may be configured to control the amount of torque transferred to the output shaft.

Various features of this invention will become apparent to those skilled in the art from the following detailed description, which illustrates embodiments and features of this invention by way of non-limiting examples.

### BRIEF DESCRIPTION OF THE DRAWINGS

Embodiments of the invention will now be described, by way of example, with reference to the accompanying drawings, wherein:

FIG. 1 is a cross-sectional view of a device in accordance with an embodiment of the invention.

FIG. 2 is a schematic of a torque path of a device in accordance with an embodiment of the invention.

FIG. 3 is a schematic of the relationship between the torque increase to a rear axle of a motor vehicle and engagement of the clutch of the device in accordance with an embodiment of the invention.

FIG. 4 is a schematic showing the interaction between an anti-lock braking system and a device in accordance with an embodiment of the invention.

### DETAILED DESCRIPTION

Reference will now be made in detail to embodiments of the present invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as embodied in or defined by the appended claims.

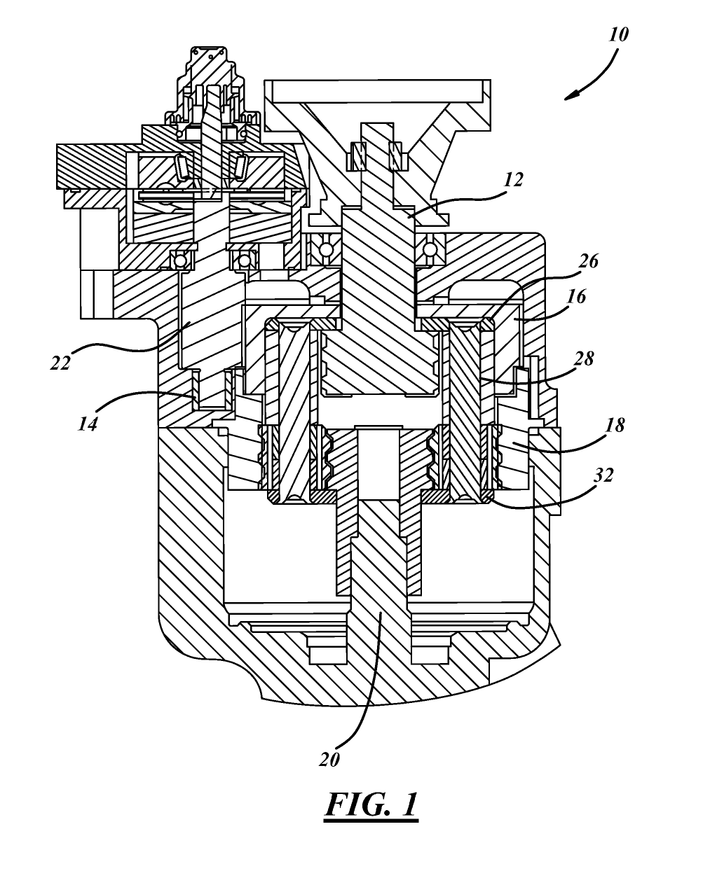

Referring now to FIG. 1, which illustrates a cross-sectional view of a device 10 in accordance with an embodiment of the invention, device 10 includes input shaft 12, clutch 14, first gear 16, second gear 18, and output shaft 20. First gear 16 and second gear 18 may comprise a component of a planetary gear set. In an embodiment, first gear 16 and second gear 18 may comprise ring gears as illustrated in FIG. 1. However, it is understood by those of ordinary skill in the art that first gear 16 may comprise a ring gear, a sun gear, a planet gear and carrier and second gear 18 may comprise a ring gear, a sun gear, a planet gear and carrier. At least a portion of device 10 may, for example, be disposed between a drive shaft and a rear differential of a motor vehicle in an embodiment. Device 10 may be configured to operate under various temperature conditions. When a motor vehicle is in front wheel drive mode, device 10 may be open in the driveshaft to the rear axle of the motor vehicle. Torque may be transferred through device 10 to the rear axle by sending an electrical current to clutch 14. When clutch 14 is fully engaged (e.g., locked up), full driveline torque may be transferred to the rear axle of the motor vehicle and device 10 may overdrive the rear axle. In an embodiment, device 10 may overdrive the rear axle by 6% as compared to the front axle. Clutch 14 may be slipped, thereby controlling the amount of relative overspeed to the rear axle from 0 to 6% in an embodiment. A powertrain control module (PCM) of the motor vehicle may control the operation of clutch 14. The PCM may have many inputs, including speed sensors on four wheels of the motor vehicle.

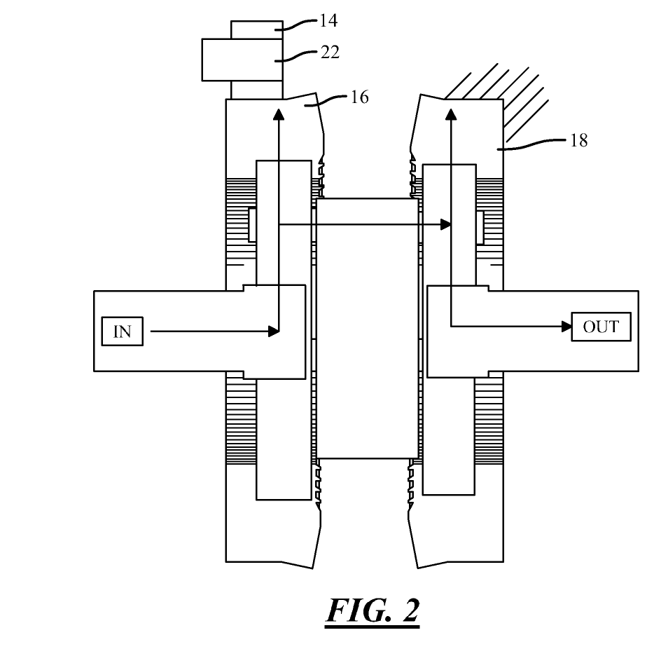

Input shaft 12 may be provided for supplying torque. FIG. 1 shows an example of an input shaft flange that might be connected to an input shaft. In an embodiment, input shaft 12 may be rotated by an electric motor. Input shaft 12 may also be rotated by a step-up gear-driven motor using a ball ramp. A device in accordance with the present invention may provide several advantages. The device may, for example, without limitation consume only up to about 3 amps of controlling current, thereby requiring only a relatively small motor in comparison to the amount of horsepower that may be delivered. By way of further example, without limitation, device 10 may provide approximately 104 horsepower or more at approximately 2.5 amps of controlling current. Device 10 may provide, for example, approximately 300 foot-lb. of torque or more at approximately 24 W of power. Referring now to FIG. 2, the torque supplied by input shaft 12 may be split between first gear 16 and second gear 18.

Referring again to FIG. 1, clutch 14 may be provided for selectively transferring torque. Clutch 14 may be provided so that device 10 may control the amount of torque transferred to output shaft 20. Clutch 14 may be configured to manage just a fraction of the available (i.e., driveline) torque, while providing a functional equivalent amount of power as a clutch that is configured to manage all the available (i.e., driveline) torque. For example, clutch 14 may be configured to manage half of the available torque, while providing a functional equivalent of power as a clutch that is configured to manage all of the available torque. Clutch 14 may be able to manage a fraction of the available torque, for example, by splitting torque through (e.g., planetary) gear sets as described in more detail below and generally illustrated in FIG. 2. Because of its configuration to manage only a fraction of the driveline torque, clutch 14 may be adapted or configured to better address vehicle packaging constraints. That is, a clutch as disclosed in accordance with teachings of embodiments of the present invention may be smaller in size than a clutch configured to manage all of the available driveline torque.

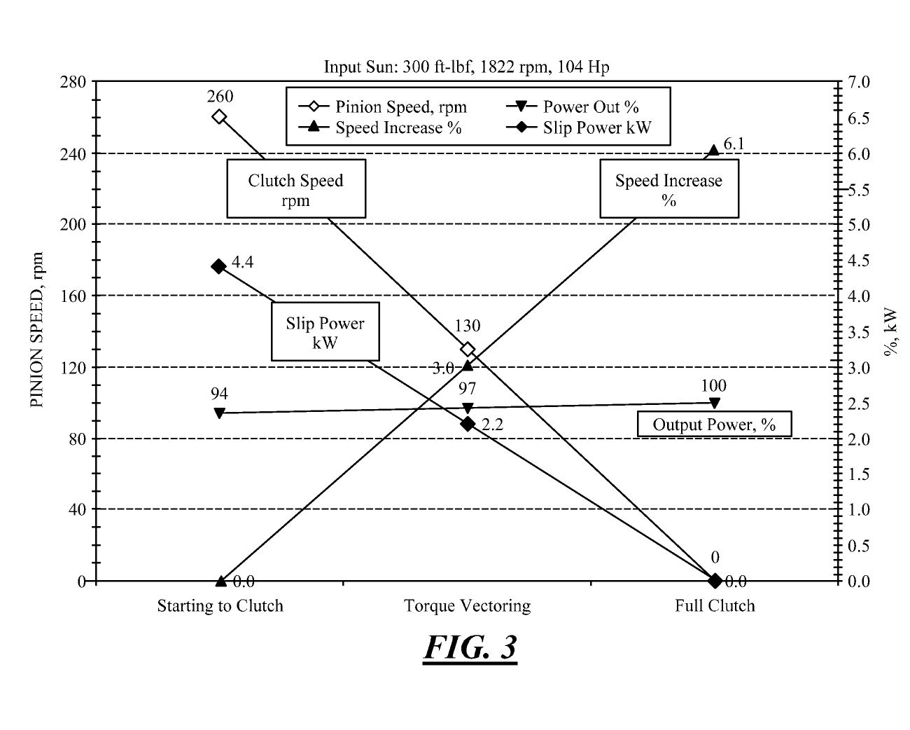

The operation of clutch 14 may be configured to vary the speed of rotation of first ring gear 16. In particular, the operation of clutch 14 may prevent or hinder movement (i.e., rotation) of first gear 16 when clutch 14 is engaged, for example, or allow for or facilitate movement (i.e., rotation) of first gear 16 when clutch 14 is released, for example. By varying the speed of gear 16, the ratio of the speed of output shaft 20 to the speed of input shaft 12 may be varied. Referring now to FIG. 3, when clutch 14 is fully engaged and movement of first gear 16 is prevented, all available torque may be transferred from input shaft 12 to output shaft 20, resulting in a maximum increase in the difference in speed supplied to the front wheel and the rear wheel of the motor vehicle utilizing device 10. Still referring to FIG. 3, when clutch 14 is fully released and movement of first gear 16 is fully permitted, no torque is transferred from input shaft 12 to output shaft 20, resulting in a substantially identical speed supplied to the front wheel and the rear wheel of the motor vehicle utilizing device 10.

Accordingly, by operation of clutch 14, device 10 may transfer no torque, partial torque, or all available torque from input shaft 12 to output shaft 20. Clutch 14 may be configured to be released (including, for example, fully released) when the speed of the rear wheel of the motor vehicle differs from the speed of the front wheel of the motor vehicle, which may be an indication of a slip condition or loss of traction. In accordance with an embodiment of the invention, clutch 14 may become fully released or fully engaged within approximately 50 milliseconds.

In an embodiment, device 10 may include pinion gear 22. Pinion gear 22 may be connected to clutch 14. Pinion gear 22 may also be configured to engage first gear 16. In particular, pinion gear 22 may include a set of gear teeth that mesh with an additional set of gear teeth of first gear 16. Pinion gear 22 may therefore act as a clutch control gear.

Device 10 may include first gear 16 that is provided for connection to clutch 14. First gear 16 may be a component of a first planetary gear set. As illustrated, first gear 16 may comprise a ring gear. However, it is understood by those of ordinary skill in the art that first gear 16 may comprise any component of a first planetary gear set. The first planetary gear set may include first ring gear 16, a first sun gear (e.g., integrated with input shaft 12), and a first set 26 of planets and planet carrier. First set 26 of planets may include, for example, four planets. The first planetary gear set may have a first gear ratio. The first gear ratio may be determined by the diameter of the first planetary gear set. In an embodiment, first ring gear 16 is not configured to rotate when clutch 14 is fully engaged. When clutch 14 is fully engaged, movement (i.e., rotation) of pinion gear 22 is prevented, which in turn prevents movement of first gear 16. In an embodiment, first gear 16 is configured to rotate when clutch 14 is fully released. When clutch 14 is fully released, movement (i.e., rotation) of pinion gear 22 is allowed, which in turn allows movement of first gear 16.

Device 10 may include second gear 18 that is provided for connection to first gear 16. Second gear 18 may be fixed to device 10 so that second gear 18 is not free to rotate. Second gear 18 may be a component of a second planetary gear set. As illustrated, second gear 18 may comprise a ring gear. However, it is understood by those of ordinary skill in the art that second gear 18 may comprise any component of a second planetary gear set. In other words, although second gear 18 may be a ring gear that is not configured to rotate, it should be understood by those of ordinary skill in the art that other components of the second planetary gear set may be configured not to rotate. In an embodiment, the first and second planetary gear sets may be connected in series (i.e., back-to-back) via a common carrier 28.

The second planetary gear set may include second ring gear 18, a second sun gear (e.g., integrated with output shaft 20), and a second set 32 of planets and planet carrier. Second set 32 of planets may include, for example, four planets. The second planetary gear set may have a second gear ratio. The second gear ratio may be determined by the diameter of the second planetary gear set. The first and second gear ratios may be functionally equivalent in an embodiment. The second gear ratio may be greater than the first gear ratio in an embodiment. If the second gear ratio is greater than the first gear ratio, then output shaft 20 may rotate faster than input shaft 12. This may be described as “torque vectoring” and may allow for increasing the speed at which a driver can negotiate a curve without losing control of the motor vehicle. It is understood by those of ordinary skill in the art that any combination of first and second gear ratios may be used and remain within the spirit and scope of the invention.

Output shaft 20 may receive the torque supplied by input shaft 12. Torque that is transferred to output shaft 20 may be supplied to increase the rotation of a rear axle of the motor vehicle that utilizes device 10. In an embodiment, the torque transferred to output shaft 20 may be configured to increase the rotation of a rear axle of the motor vehicle up to about 6%, for example, as illustrated in FIG. 3. Although 6% is mentioned in detail in accordance with an embodiment of the invention, it is understood by those of ordinary skill in the art that device 10 may be configured to increase the rotation of a rear axle of a motor vehicle more or less than about 6% and remain within the spirit and scope of the invention.

In accordance with an embodiment of the invention, a system including device 10 may further include a wheel speed sensor for detecting the speed of a wheel of a motor vehicle or other means for providing feedback regarding the speed of the rear wheel. In accordance with an embodiment of the invention, the wheel speed sensor may comprise a rear wheel speed sensor. Depending upon the feedback received from the wheel speed sensor, the amount of torque transferred to output shaft 20 may be increased or decreased by engaging or releasing clutch 14, respectively. In an embodiment, when feedback from the wheel speed sensor indicates that the speed of the rear wheel has increased, clutch 14 may be configured to be fully released in order to decrease the amount of torque transferred to output shaft 20, and ultimately to the rear axle to which the rear wheel is connected.

In an embodiment, a system including device 10 may further include a wheel speed sensor or other means for providing feedback regarding the speed of the wheel for both a rear wheel and a front wheel of a motor vehicle. Both wheel speed sensors may be included to provide feedback regarding the speed of the front wheel and the speed of the rear wheel. In another embodiment, a system including device 10 may further include a wheel speed sensor or other means for providing feedback regarding the speed of all four wheels of a motor vehicle. The motor vehicle's PCM may have as inputs at least one speed sensor for at least one wheel of the motor vehicle. In an embodiment, the motor vehicle's PCM may have as inputs at least one speed sensor for four wheels of the motor vehicle. The PCM may control clutch 14 of device 10. In front wheel drive mode, device 10 may be open in the drive shaft to the rear axle. Torque may be transferred through device 10 to the rear axle by sending an electrical current to clutch 14 of device 10. When clutch 14 is fully engaged (i.e., locked up), full driveline torque may be transferred to the rear axle and device 10 may overdrive the rear axle by approximately 6% as compared to the front axle, as illustrated in FIG. 3, for example. Clutch 14 may be slipped, thereby controlling the amount of relative overspeed to the rear axle, from 0 to 6% as also illustrated in FIG. 3, for example.

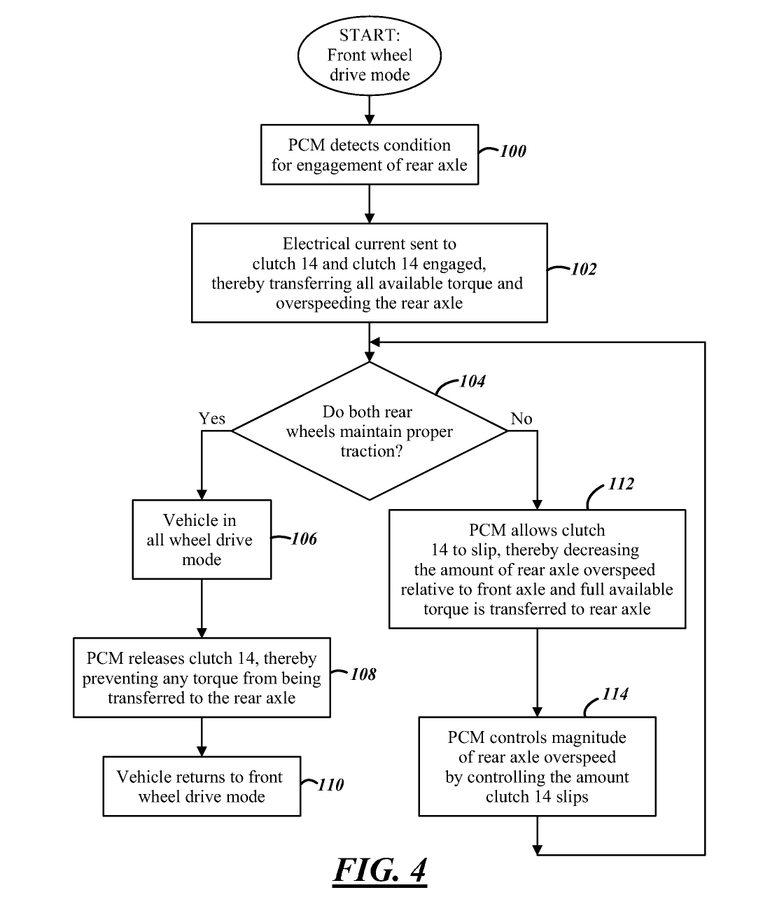

Referring now to FIG. 4, a motor vehicle's PCM may detect a condition for requiring engagement of a rear axle at step 100. A condition that may be detected by the PCM that may require engagement of a rear axle includes torque vectoring detected by a traction control system, a front tire slip (i.e., vehicle is stuck), or a road condition. A condition that may be detected by the PCM that may require engagement of a rear axle may also include feedback from the wheel speed sensors or other means for providing feedback that indicates that there is a difference in wheel speed between the front and rear wheels. In an embodiment, any detectable difference in wheel speed between the front and rear wheels may generate feedback indicating a difference in wheel speed. In another embodiment, only a difference in wheel speed between the front and rear wheels that meets a predetermined or pre-selected threshold may generate feedback indicating a difference in wheel speed. Such feedback may be indicative of a slip condition or loss of traction. When such a condition is detected, electrical current may be sent to clutch 14 of device 10 and clutch 14 may be engaged (i.e., locked up), thereby transferring all available torque and overspeeding the rear axle at step 102.

A determination is made as to whether both rear wheels maintain proper traction at step 104. Compliance in the tires can handle a 6% overspeed condition. If both rear wheels maintain proper traction at step 104, then the vehicle may be in all wheel drive mode, as illustrated at step 106. After the PCM determines that the condition requiring rear axle drive has been corrected and that all tires have traction, the PCM releases clutch 14, thereby preventing any torque from being transferred to the rear axle, at step 108. The vehicle may then return to front wheel drive mode at step 110.

If both rear wheels do not maintain proper traction at step 104, and the PCM senses that one or both rear wheels slip, the PCM allows clutch 14 to slip, thereby decreasing the amount of rear axle overspeed relative to the front axle and full available torque may be transferred to the rear axle at step 112. PCM may control the magnitude of the rear axle overspeed by controlling the amount clutch 14 slips at step 114. A new determination may then be made as to whether both rear wheels maintain proper traction, as illustrated at step 104. If both rear wheels maintain proper traction at step 104, then steps 106-110 may be completed. If both rear wheels do not maintain proper traction at step 104, then steps 112-114 may be completed.

In accordance with an embodiment of the invention, device 10 may be configured to be integrated with or used in connection with an anti-lock braking system. An anti-lock braking system may, for example, help control the transfer of torque to and from the right and left sides of a motor vehicle. For example, in some anti-lock braking systems, if one wheel is locked, more torque is provided to the opposing wheel. In particular, an anti-lock braking system may include a first device for changing the braking torques applied to a left and right wheel of the motor vehicle, as well as a controller for controlling the first device to prevent the left and right wheel from locking during operation of the motor vehicle, including during braking of the motor vehicle. The controller may determine whether one or more wheels are under anti-lock control, and may control the first device to adjust the left wheel and/or right wheel braking torque in order to prevent locking. The anti-lock braking system may be used in connection with or integrated with device 10. Together, the anti-lock braking system and device 10 may thus control both the braking torques applied to a left and right wheel of the motor vehicle, as well as the torque selectively transferred from output shaft 20 to an axle (e.g., rear axle) of the motor vehicle.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A device for a motor vehicle, comprising:
an input shaft for supplying torque;
a clutch for selectively transferring the torque;
a first gear configured for connection to the clutch;
a second gear connected to the first gear, wherein the second gear is fixed to the device so that the second gear is not free to rotate; and
an output shaft for receiving the torque;
wherein the device is configured to control the amount of torque transferred to the output shaft.

2. A device in accordance with claim 1, wherein at least a portion of the device is disposed between a drive shaft and a rear differential of the motor vehicle.

3. A device in accordance with claim 1, wherein the first gear is a component of a first planetary gear set, the first planetary gear set comprising a first ring gear, a first sun gear, and a first set of planets and a first planet carrier.

4. A device in accordance with claim 3, wherein the second gear is a component of a second planetary gear set, the second planetary gear set comprising a second ring gear, a second sun gear, and a second set of planets and a second planet carrier.

5. A device in accordance with claim 1, wherein torque is split between the first gear and the second gear.

6. A device in accordance with claim 4, wherein the gear ratio of the first planetary gear set and the second planetary gear set are functionally equivalent.

7. A device in accordance with claim 4, wherein the gear ratio of the second planetary gear set is greater than the gear ratio of the first planetary gear set.

8. A device in accordance with claim 1, wherein the transfer of torque to the output shaft is configured to increase rotation of a rear axle of the motor vehicle up to about 6%.

9. A device in accordance with claim 1, wherein the clutch is configured to manage only a fraction of the available torque, while providing the functional equivalent amount of horsepower as a clutch that is configured to manage all the available torque.

10. A device in accordance with claim 9, wherein the fraction is approximately one-half.

11. A device in accordance with claim 1, wherein the device is configured to transfer all available torque when the clutch is fully engaged.

12. A device in accordance with claim 1, wherein the first gear is not configured to rotate when the clutch is fully engaged.

13. A device in accordance with claim 1, wherein the device does not transfer torque when the clutch is fully released.

14. A device in accordance with claim 1, wherein the first gear is configured to rotate when the clutch is fully released.

15. A device in accordance with claim 1, wherein the operation of the clutch is configured to vary the speed of the first gear, thereby varying the ratio of the speed of the output shaft to the speed of the input shaft.

16. A device in accordance with claim 1, wherein the clutch is configured to be released when the speed of a rear wheel of the motor vehicle differs from the speed of a front wheel of the motor vehicle.

17. A device in accordance with claim 4, wherein the first and second sets of planets comprise four planets.

18. A device in accordance with claim 4, wherein the first and second planetary gear sets are connected in series via a common carrier.

19. A device in accordance with claim 1, further comprising a pinion gear connected to the clutch, wherein the pinion gear is configured to engage the first gear.

20. A device in accordance with claim 1, further comprising a step-up gear-driven motor using a ball ramp to engage the clutch.

21. A device in accordance with claim 1, further comprising an electric motor.

22. A device in accordance with claim 4, wherein the first and second planetary gear sets are back-to-back.

23. A device in accordance with claim 1, wherein the device consumes 3 amps or less of controlling current.

24. A device in accordance with claim 1, wherein the device can provide approximately 104 horsepower or more at approximately 2.5 amps of controlling current.

25. A device in accordance with claim 1, wherein the device can provide approximately 300 foot-lb. of torque or more at approximately 24 W of power.

26. A device in accordance with claim 1, wherein the clutch can respond within 50 milliseconds or less.

27. A device in accordance with claim 1, further comprising a wheel speed sensor.

28. A device in accordance with claim 27, wherein the amount of torque transferred to the output shaft corresponds to feedback received from the wheel speed sensor.

29. A device in accordance with claim 28, wherein the clutch is configured to be fully released when the wheel speed sensor feedback indicates that the speed of a rear wheel of the motor vehicle differs from the speed of a front wheel of the motor vehicle.

30. A device in accordance with claim 1, further comprising an anti-lock braking system for controlling the transfer of torque to and from the right and left sides of the motor vehicle.

31. A system for a motor vehicle, comprising:
a first device for changing the braking torques applied to a left and right wheel of the motor vehicle;
a controller for controlling the first device to prevent the left and right wheel from locking;
a second device, comprising:
an input shaft for supplying torque;
a clutch for selectively transferring the torque;
a first gear configured for connection to the clutch;
a second gear connected to the first gear, wherein the second gear is fixed to the second device so that the second gear is not free to rotate; and
an output shaft for receiving the torque;
wherein the second device is configured to control the amount of torque transferred to the output shaft,
wherein the system controls the braking torques applied to a left and right wheel of the motor vehicle and the torque transferred from the output shaft to an axle.

32. A system for a motor vehicle, the system comprising a drive shaft, a rear differential, and a device disposed between the drive shaft and the rear differential, the device comprising:
an input shaft for supplying torque;
a clutch for selectively transferring the torque;
a first gear set including a first ring gear configured for connection to the clutch;
a second gear set including a second ring gear connected to the first ring gear, wherein the second ring gear is fixed to the device so that the second ring gear is not free to rotate; and
an output shaft for receiving the torque;
wherein the first and second gear sets are connected in series via a common carrier and the torque is split between the first ring gear and the second ring gear; and
wherein the device is configured to transfer up to all available torque to the output shaft when the clutch is fully engaged and the device does not transfer torque to the output shaft when the clutch is fully released.

33. A system in accordance with claim 32, wherein the first gear set and the second gear set comprise planetary gear sets.

34. A system in accordance with claim 32, including a wheel speed sensor.

35. A system in accordance with claim 34, wherein the amount of torque transferred to the output shaft is at least in part controlled by feedback received from the wheel speed sensor.

36. A system in accordance with claim 35, wherein the clutch is configured to be released when the wheel speed sensor feedback indicates that the speed of a rear wheel of the motor vehicle differs from the speed of a front wheel of the motor vehicle.
